(19) United States
(12) Patent Application Publication
(10) Pub. No.: US 2026/0369997 A1
(43) Pub. Date: Nov. 19, 2026

(54) GEOGRAPHICAL ASSET PERFORMANCE MANAGEMENT FOR PHOTOVOLTAIC ASSET SYSTEMS

(71) Applicant: Fluence Energy, LLC, Arlington, VA (US)

(72) Inventors: Gianmarco Pizza, Zurich (CH); Yuyan Guo, Uetikon am See (CH); Antonio Notaristefano, Winterthur (CH); Ernesto Pizza, Fällanden (CH); Manuel Adrian Paccoia, Bremgarten (CH)

(73) Assignee: Fluence Energy, LLC, Arlington, VA (US)

(21) Appl. No.: 19/674,402

(22) Filed: May 12, 2026

Related U.S. Application Data
(60) Provisional application No. 63/804,795, filed on May 13, 2025.

(51) Int. Cl. H02J 3/0012; H02J 13/10; H02J 13/12; H02J 13/181; H02S 50/00; H02J 101/24; H02J 103/30

(52) U.S. Cl. CPC H02J 3/0012; H02J 13/10; H02J 13/12; H02J 13/181; H02S 50/00; H02J 2101/24; H02J 2103/30

(57) ABSTRACT

A method for geographical asset performance management of a photovoltaic (PV) system includes generating a geographical map identifying a PV system having a plurality of PV components. The system includes a map view visualization displaying non-numerical performance indicator levels for each of the PV components based on a coloring logic. The system and method identify an underperforming PV component and display the location of the underperforming PV component based on the coloring logic in the map view, and further determine an optimized route of travel for a technician to reach the underperforming PV component.

### CROSS-REFERENCE TO RELATED APPLICATIONS

The present application claims the benefit of priority to United States Provisional Application No. 63/804,795 filed on May 13, 2025, which is hereby incorporated by reference in its entirety.

### INTRODUCTION

The concepts described herein relate generally to a photovoltaic (PV) asset system, and more specifically to enhancing analysis performance capabilities of a PV asset system.

A PV system, also referred to in the art as a solar power system, is an electric power system designed to supply solar power by means of photovoltaics. The system may include an arrangement of multiple components, including solar panels to absorb and convert sunlight into electricity, and a solar inverter to convert a direct current (DC) output of the solar panels to alternating current (AC). PV systems may connect strings of solar panels, i.e., a series array of solar panels connected in a chain, to create an electrical circuit. The solar panels may be connected to a PV combiner box that provides a joint connection between the strings of solar panels and an inverter. The PV system is typically connected to the utility grid, but may also utilize DC battery-based storage.

The performance of a PV system is dependent upon multiple factors. In addition to system component failures, a PV system is susceptible to environmental conditions such as shade from nearby trees, or dirt/airborne debris partially covering the solar panel(s). Thus, PV system performance is monitored for system performance and degradation. Further, different conditions may be present in different areas of the PV system, which in turn may necessitate distinct types of resolutions.

### SUMMARY

The solutions disclosed herein provide a geographically based user interface that includes a map view visualization of a photovoltaic (PV) asset for performance management purposes. Performance management of the PV asset may be accomplished through the use of specialized trackers and monitors. Another approach may be through the use of performance monitors.

In particular, a method of geographical asset performance management of a PV system in accordance with a non-limiting embodiment includes generating a geographical map identifying a PV system having multiple PV components. The geographical map includes a map view visualization. The method in one or more embodiments may include displaying information about a selected PV component using an image generator, e.g., as a non-numerical performance indicator level of each of the PV components in the map view visualization, which may occur based on a coloring logic. The method may also include identifying a qualitatively and/or quantitatively underperforming PV component while also displaying the location of the underperforming PV component based on, e.g., the coloring logic in the map view. Embodiments of the method further include determining an optimized route of travel for a technician to reach the underperforming PV component.

The plurality of PV components may include an inverter, a combiner box, and/or a string of solar panels. Each of the PV components may be represented with a two-dimensional block in the map view visualization.

The coloring logic in one or more embodiments may be based on a key performance indicator in a user selected period of time. The method may include displaying a video of the performance level of each of the PV components in the map view visualization over a user-selected period of time, or displaying information about a selected PV component via a suitable image generator, e.g., a display screen.

The coloring logic noted above may include an indication of a type of the underperforming PV component. The coloring logic may provide an indication of the severity of the underperformance.

The performance level indicator disclosed herein may include a plurality of performance types. The map view visualization may be interactive. The information may include a name of the selected PV component and a value of the performance indicator level.

An aspect of the disclosure includes a system of geographical asset performance management of a PV system having an image generator logic node (e.g., one or more processors coupled with and configured to execute image generating logic/instructions) configured to generate a geographical map. The map identifies a PV system that includes a plurality of PV components, as well as a map view visualization. The image generator logic node may display information about a selected PV component, e.g., a non-numerical performance indicator level of each of the PV components in the map view visualization, for instance based on a coloring logic. Further, the system in one or more implementations may include a processing logic node (or nodes) configured to identify an underperforming PV component. The image generator logic node may display the location of the underperforming PV component based on the coloring logic in the map view. The processing logic node may also determine an optimized route of travel for a technician to reach the underperforming PV component.

The PV components may include an inverter, a combiner box, and/or a string of solar panels. The coloring logic node in one or more embodiments is based on a key performance indicator in a user selected period of time. The image generator logic node may display a video of the performance level of each of the PV components in the map view visualization over a user selected period of time.

The coloring logic node may also include an indication of a type of the underperforming PV component. The image generator logic node may generate an interactive map view visualization or display information about a selected PV component.

Another aspect of the disclosure may include the information containing a name of the selected PV component and a value of the performance indicator level.

Another aspect of the disclosure may include a method of geographical asset performance management of a PV system. An embodiment of the method may include generating a geographical map identifying a PV system that includes multiple PV components, where the geographical map includes a map view visualization. The method may include displaying a non-numerical performance indicator level of each of the PV components in the map view visualization based on a coloring logic node. The method may also include identifying an underperforming PV component while also displaying the location of the underperforming PV component based on the coloring logic node in the map view.

The method in accordance with one or more embodiments may also include determining an optimized route of travel for a technician to reach the underperforming PV component. The multiple PV components as noted above may include an inverter, a combiner box, and/or a string of solar panels. Each of the PV components may be represented with a two-dimensional block in the map view visualization. The coloring logic node may be based on a key performance indicator in a user selected period of time, including an indication of a type of the underperforming PV component. The coloring logic node provides an indication of the severity of the underperformance. The performance level indicator includes a plurality of performance types, with the map view visualization being interactive.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is an illustration of example photovoltaic (PV) system components in accordance with the disclosure.

FIG. 2 is a topographical illustration of a PV system in its actual geographical location.

FIG. 3 is a detailed illustration of a portion of a in accordance with one aspect of the disclosure.

FIG. 4 is an example time lapse display of a map view visualization of a PV system.

FIG. 5 illustrates a method of geographical asset performance management of a PV system.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible to embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5 % of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

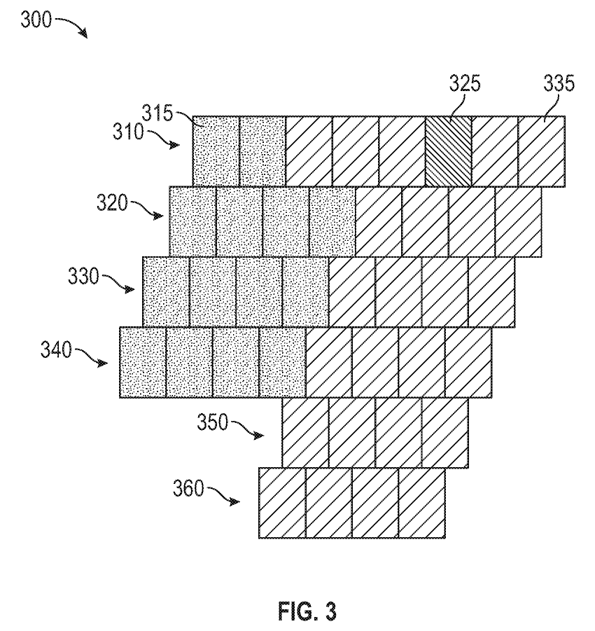

Referring to the drawings, the leftmost digit of a reference number identifies the drawing in which the reference number first appears (e.g., a reference number “310” indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may be functionally the same, but may be located at different points in a simulation arena).

As employed herein, terms such as “vertical”, “horizontal”, “left”, “right”, “upper”, “lower”, “top”, “bottom” and similar expressions are non-limiting terms that merely describe the various elements as illustrated in the Figures and are not intended to limit the scope of the disclosure.

Photovoltaic (PV) systems, also known as a solar power plant, solar park, or solar farm, may be a large-scale grid-connected system designed for the commercial supply of electricity. PV systems differ from the concept of concentrated solar power that uses the heat of the sun to drive a variety of conventional generator systems.

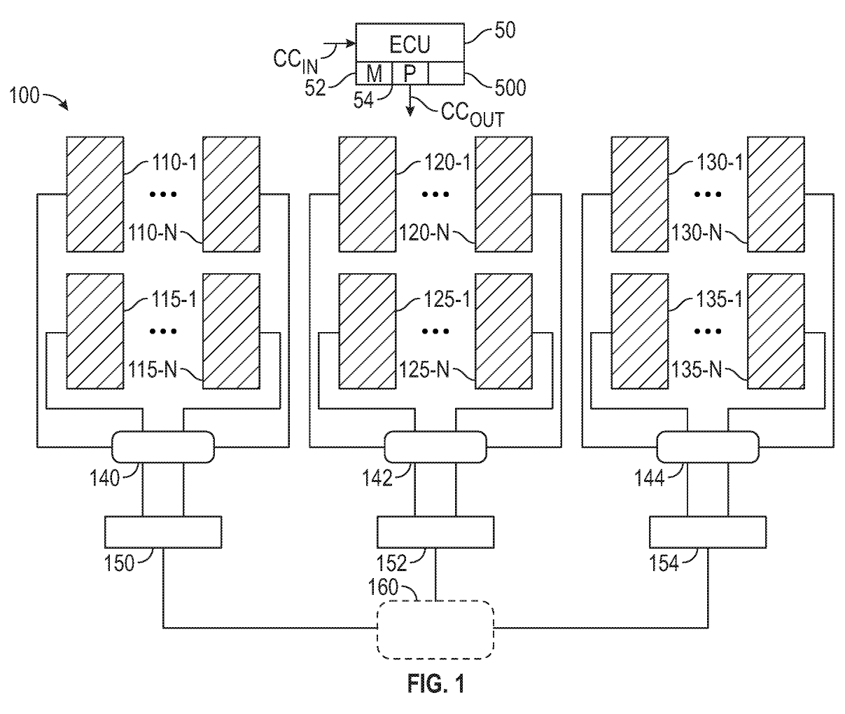

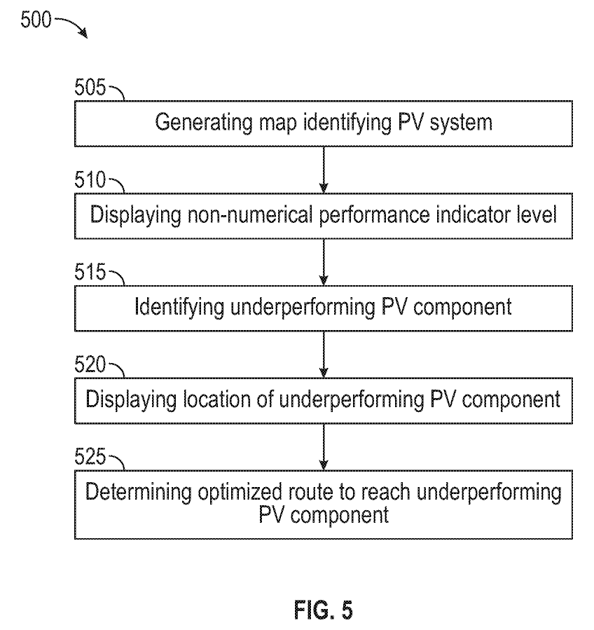

As illustrated in FIG. 1, a PV system 100 may include a variety of components, according to an embodiment of the present disclosure. An electronic control unit (ECU) 50 having memory (M) 52 and one or more processors (P) 54 receives input signals CC_{IN} and provides output signals CC_{OUT} in the course of performing a method 500, an example of which is described below with reference to FIG. 5. The term "signal" as used herein refers to a physically discernible indicator that conveys information, and may be a suitable waveform (e.g., electrical, optical, magnetic, mechanical or electromagnetic), such as DC, AC, sinusoidal-wave, triangular-wave, square-wave, vibration, and the like, that is capable of traveling through a medium.

The ECU 50 is shown schematically for simplicity, but in practice may include networked mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

Memory 52 includes a non-transitory storage medium/memory component(s) and storage devices (read only, programmable read only, random access, hard drive, etc.). Non-transitory memory component may be capable of storing machine readable instructions in the form of one or more software or firmware programs or routines, combinational logic circuit(s), input/output circuit(s) and devices, signal conditioning and buffer circuitry and other components that may be accessed by one or more of the processors 54 to provide a described functionality. Input/output circuit(s) and devices include analog/digital inverters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables.

Communication herein may be accomplished using a direct wired point-to-point link, a networked communication bus link, a wireless link, or another communication link. Communication may include exchanging data signals, including, for example, electrical signals via a conductive medium; electromagnetic signals via air; optical signals via optical waveguides, etc. The data signals may include discrete, analog and/or digitized analog signals representing inputs from sensors, actuator commands, and communication between controllers.

For example, the PV system 100 may include multiple solar panel strings electrically coupled, for example solar panel strings 110-1 through 110-N, solar panel strings 115-1 through 115-N, solar panel strings 120-1 through 120-N, solar panel strings 125-1 through 125-N, solar panel strings 130-1 through 130-N, and solar panel strings 135-1 through 135-N. In addition, the PV system 100 may include combiner boxes 140, 142, and 144, that may be used to connect and combine the power output of solar panels. The combiner box 140 may be used to combine the power output of, e.g., the solar panel strings 110-1 through 110-N and the solar panel strings 115-1 through 115-N. The number and configuration of solar panels with one or more combiner boxes is a matter of design based on a desired voltage and/or capacity of the solar panels and combiner boxes.

The PV system 100 of FIG. 1 may also include the use of inverters, for example the inverters 150, 152, and 154, which are electrically coupled to one or more combiner boxes, and which may be used to convert the direct current (DC) output of the solar panel strings noted above through the combiner boxes 140, 142, and 144 to provide alternating current (AC) to an AC/Out – AC/In connection point 160. Further, the AC/Out – AC/In connection point 160 may be used to connect with external networks or generators. In an embodiment, the PV system 100 may also include battery systems (not shown) to store the DC output of the solar panels. The configuration of inverters and combiner boxes illustrated in FIG. 1 are a single example of possible configurations, which are not meant to limit the scope of this disclosure.

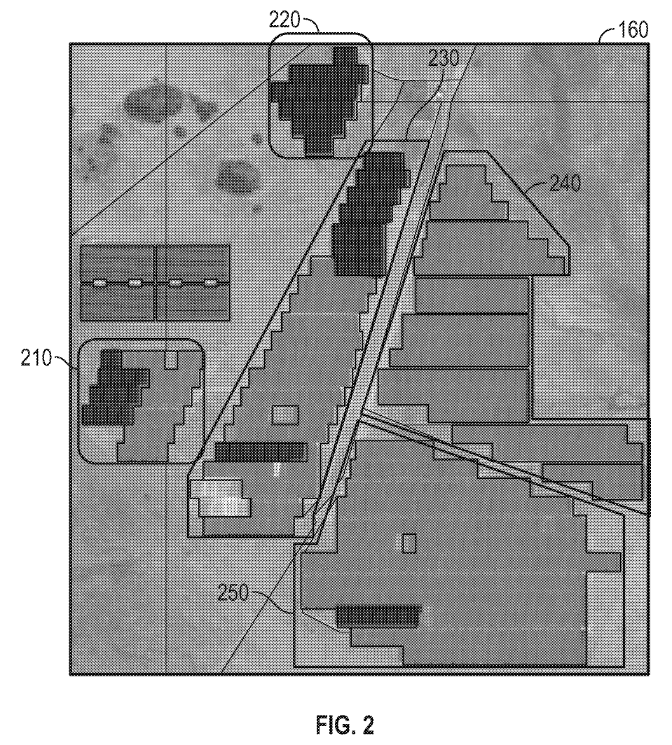

FIG. 2 illustrates a user interface 160 as part of (or in communication with) the ECU 50 of FIG. 1. The user interface 160 includes a topological illustration 200 of the above-noted PV system 100 according to an embodiment of the present disclosure. Such a user interface may be part of an asset performance management system for the analysis of PV asset performance. The user interface 160 may include a visualization of the various components within a PV system 100. The visualization may be based on satellite imagery, map data, drone images, or other methods of image capture or generation. As shown in FIG. 2, the topological illustration 200 may include multiple sections or clusters of PV components, for example, a component cluster 210, 220, 230, 240, and 250.

The various components within each of the example clusters 210, 220, 230, 240, and 250 may include equipment such as inverters, combiner boxes, solar panel strings, etc., for example as discussed in FIG. 1. Such components are shown in their actual geographical location. Further, the components may be represented as two-dimensional blocks in a map view, as will be further described in FIG. 3. In addition, the coloring logic node may be applied to each individual block based on its performance. The coloring logic node may include a defined scale, for example, various colors may correspond to a performance level, thus enabling one to identify one or more underperforming PV components. Performance may be affected by environmental factors such as shading or soiling of solar panel strings. For example, the buildup of dirt or debris may degrade the performance of a solar panel string on an ongoing basis where shading from a nearby tree may affect a solar panel string only at certain times of the day or certain seasons of the year.

Further, the coloring logic node may also indicate a severity of the underperformance, for example by a specific color or intensity. The coloring logic node may be referred to as a performance level indicator in which such an indicator may also convey a type of performance. For example, an under or over voltage condition, an under or over temperature condition, an inverter failure, a solar cell failure, a combiner box failure, etc.

In one or more embodiments, the map view may represent component performance in a selected time period. For instance, the map may illustrate the performance or evolution of the PV component over time. In one example, the performance may be represented as a video that includes a collection of the performance visualization of the map in consecutive time frames. For example, a user may select the visualization of a video for a month with daily time frames. Thus, in a possible implementation, underperformance due to shading may manifest itself only at certain times of the day.

Further, the user interface may include the use of an asset performance management system to identify components with performance issues on the map and optimize maintenance operations. This may occur by defining an area of intervention where the faulty components are located, including inference to a possible root cause of the fault by illustrating the adjacent component affected by low performance. Further, an optimized route to a particular PV component may be generated as the map illustrates the physical layout of the PV system and therefore may assist a technician in locating and traveling to a particular component.

FIG. 3 is an illustration of a configuration of the PV system enclosures 300 with PV components placed in their geographical locations, according to an embodiment of the present disclosure. FIG. 3 is shown as an example illustration of the cluster 210 from FIG. 2. PV system enclosures 300 are represented as six rows of enclosures, e.g., rows 310, 320, 330, 340, 350, and 360. Further, each PV component, or enclosure, is illustrated with some type of coloring logic. The coloring logic node may correspond to a legend that is indicative of that PV component’s health or performance indicator. The coloring logic node is meant to convey information about that enclosure without the need to decode tables, bar charts, graphs, etc.

FIG. 3 illustrates three different example versions of coloring logic. However, this example is illustrative and may consist of any number of patterns, intensities, colors, hues, shades, etc., and are merely examples to convey the concept. For instance, pattern 335 may be indicative of a normal operating range of a PV component as shown in five enclosures in row 310, and four enclosures each in rows 320, 330, 340, 350, and 360. Pattern 325, as shown in a single enclosure in row 315, may be an indication of a sub-optimal operating condition, for example a slight undervoltage, but not critical. Pattern 315 for its part may be indicative of a critical condition, as shown in two enclosures in row 310, and four enclosures in each of rows 320, 330, and 340.

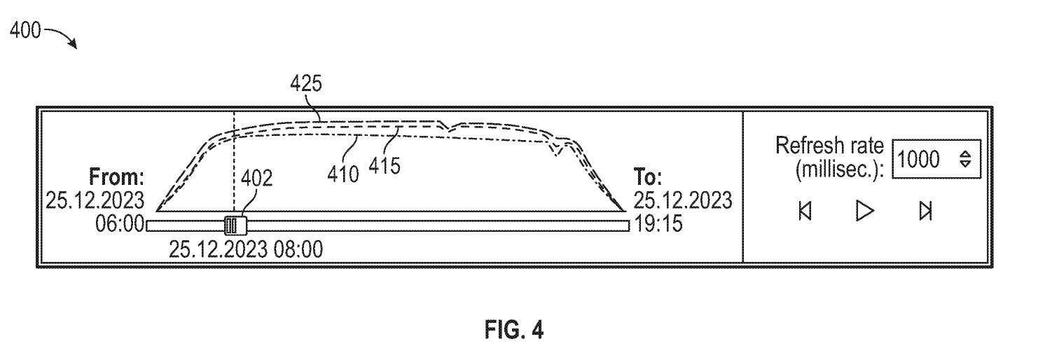

The representative map in FIG. 3 may also be interactive. For instance, to view additional details of a particular PV component, a user may select a PV component to reveal a pop-up window, or other method of display, with additional detail information regarding one or more key performance indicators. Also, as is described in FIG. 4, the map view may be seen in a video mode as a sequence of time frames with coloring logic based on the values of the various PV components over a selected period of time. Such a video mode may allow for the identification of the evolution of an underperformance of components over time. For example, examples of issues that may be detectable with the map view are identification of areas of the power plant that may be more affected by soiling issues and identification of underperforming adjacent components that may be caused by electrical connection interruption of tracker faults.

FIG. 4 illustrates a time lapse control 400 of a map view visualization of an example PV system according to an embodiment of the present disclosure. In this representative example, the time lapse control 400 show captures of a map view visualization, for example as shown in FIG. 3, but over time, in this example on a single day from 6:00 hours to 19:15 hours, i.e., 6:00 am to 7:15 pm. In particular, a slider 402 is positioned at the time mark of 8:00 on December 25, 2023, and may be represented by FIG. 3. Graph line 410, graph line 415, and graph line 425 may represent performance levels associated with the PV system. For example, graph line 410 may represent a baseline in which all of the PV components are operating at a normal level. Graph line 415 may illustrate the amount of PV components that may be operating outside of a normal range, but not in a critical range. And graph line 425 may represent those PV components operating in an underperforming or critical range and in need of maintenance.

By moving the slider 402, a user may see graphically how the map view visualization changes over time. Alternatively, the set of images associated with the timeline may be viewed as a video.

FIG. 5 illustrates a method 500 for geographical asset performance management of a PV system. FIG. 5 may begin with a step or logic block 505 with generating a geographical map identifying a PV system that includes a plurality of PV components, where the geographical map includes a map view visualization. As discussed in FIG. 3, a user interface 160 may be part of an asset performance management system for the analysis of photovoltaic assets where the user interface may include a visualization of the various components within a PV system. The visualization may be based on satellite imagery, map data, drone images, or other methods of image capture or generation.

At block 510, the method 500 may include displaying a non-numerical performance indicator level of each of the PV components in the map view visualization based on coloring logic. As discussed above with reference to FIG. 3, each PV component or enclosure is illustrated with some type of coloring logic. The coloring logic use by the described coloring logic node may correspond to a legend that is indicative of that PV component’s health or performance indicator. For example, pattern 325, as shown in a single enclosure in row 315 may be an indication of a sub-optimal operating condition, e.g., a slight undervoltage, but not critical, whereas pattern 315 may be indicative of a critical condition, as shown in two enclosures in row 310, and four enclosures in each of rows 320, 330, and 340.

At block 515, the method 500 may include identifying an underperforming PV component. Identifying an underperforming PV component may be accomplished through sensors and communications components to detect and determine an underperforming PV component.

At block 520, the method 500 may include displaying a location of the underperforming PV component based on the coloring logic in the map view. For example, as discussed in block 510 the map visualization may display different patterns in each of the PV components that are indicative of key performance indicators within each enclosure.

At block 525, the method 500 may include determining an optimized route of travel for a technician to reach the underperforming PV component. As discussed above with reference to FIG. 2, an optimized route to a particular PV component may be generated as the map illustrates the physical layout of the PV system and therefore may assist a technician in locating and traveling to a particular component.

Method 500 is finished after completion of block 525.

The present disclosure may be embodied in many different forms. Representative examples are shown in the various drawings and described herein in detail as non-limiting examples of the disclosed principles. To that end, elements and limitations described herein, but not explicitly set forth in the claims, are not to be incorporated into the claims, singly or collectively, by implication, inference, or otherwise.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

We claim:

1. A method of geographical asset performance management of a photovoltaic (PV) system having a plurality of PV components, the method comprising:
generating, via a processor, a geographical map identifying the PV system, wherein the geographical map includes a map view visualization;
displaying, via a user interface, a non-numerical performance indicator level of each PV component in the plurality of PV components in the map view visualization based on a coloring logic;
identifying an underperforming PV component via the processor;
displaying a location of the underperforming PV component based on the coloring logic in the map view visualization; and
determining, via the processor, an optimized route of travel for a technician to reach the underperforming PV component.

2. The method of claim 1, wherein the plurality of PV components includes an inverter, a combiner box, and/or a string of solar panels.

3. The method of claim 1, wherein the each PV component of the plurality of PV components is represented with a two-dimensional block in the map view visualization.

4. The method of claim 1, wherein the coloring logic is based on a key performance indicator in a user-selected period of time.

5. The method of claim 1, further comprising: displaying a video of the performance level of each of the PV components in the map view visualization over a user-selected period of time.

6. The method of claim 1, wherein the coloring logic includes an indication of a type of the underperforming PV component.

7. The method of claim 1, wherein the coloring logic includes an indication of a severity of underperformance of the underperforming PV component.

8. The method of claim 1, wherein the performance indicator level includes a plurality of performance types.

9. The method of claim 1, wherein the map view visualization is interactive.

10. The method of claim 9, further comprising: displaying information about a selected PV component of the plurality of PV components.

11. The method of claim 10, wherein the information includes a name of the selected PV component and a value of the performance indicator level.

12. A system of geographical asset performance management of a photovoltaic (PV) system that includes a plurality of PV components, the system comprising:
an image generator logic node configured to generate a geographical map identifying a PV system, wherein the geographical map includes a map view visualization, and to display a non-numerical performance indicator level of each PV component in the plurality of PV components in the map view visualization based on a coloring logic; and
a processing logic node configured to identify an underperforming PV component of the plurality of PV components, wherein the image generator logic node is configured to display a location of the underperforming PV component based on the coloring logic in the map view, wherein
the processing logic node is configured to determine an optimized route of travel for a technician to reach the underperforming PV component.

13. The system of claim 12, wherein the plurality of PV components includes an inverter, a combiner box, and/or a string of solar panels.

14. The system of claim 12, wherein the coloring logic is based on a key performance indicator in a user-selected period of time.

15. The system of claim 12, wherein the image generator logic node is further configured to display a video of the performance level of each of the PV components in the map view visualization over a user-selected period of time.

16. The system of claim 12, wherein the coloring logic node is configured to include an indication of a type of the underperforming PV component.

17. The system of claim 12, wherein the image generator logic node is further configured to generate an interactive map view visualization.

18. The system of claim 17, wherein the image generator logic node is further configured to display information about a selected PV component.

19. The system of claim 18, wherein the information includes a name of the selected PV component and a value of the performance indicator level.

20. A method of geographical asset performance management of a photovoltaic (PV) system that includes a plurality of PV components, the method comprising:
generating a geographical map that identifies a PV system, the geographical map including an interactive map view visualization;
displaying a non-numerical performance indicator level of each of the PV components in the plurality of PV components in the map view visualization based on a coloring logic, the plurality of PV components including an inverter, a combiner box, and/or a string of solar panels, wherein the performance indicator level includes a plurality of performance types;
identifying an underperforming PV component of the plurality of PV components;
displaying a location of the underperforming PV component based on the coloring logic in the map view; and
determining an optimized route of travel for a technician to reach the underperforming PV component, wherein:
each of the plurality of PV components is represented with a two-dimensional block in the map view visualization; and
the coloring logic (i) is based on a key performance indicator in a user-selected period of time, (ii) includes an indication of a type of the underperforming PV component, and (iii) includes an indication of a severity of the underperformance.
